(19) United States
(12) Patent Application Publication
(10) Pub. No.: US 2017/0295611 A1
(43) Pub. Date: Oct. 12, 2017

(54) ELECTRIC STOVETOP

(71) Applicant: Andre Castro GURGEL, Ubatuba (BR)

(72) Inventor: Andre Castro GURGEL, Ubatuba (BR)

(21) Appl. No.: 15/160,840

(22) Filed: May 20, 2016

(30) Foreign Application Priority Data
Apr. 7, 2016 (BR) 10 2016 007698 6

(51) Int. Cl. H05B 3/14; H05B 3/68

(52) U.S. Cl. CPC H05B 3/141; H05B 3/68

(57) ABSTRACT

An electric stovetop includes a vitroceramic top part, an electric heating element built-in below the top part, and a bottom box with the electric heating element mounted through the bottom box. The electrical heating element can include parallel and equidistant tracks defining a rectangular heating area. Each track is divided into three segments, a large central part and two smaller end parts. Each track is positioned corresponding to a sliding button for controlling power to start heating and to control intensity of heat. The sliding button sets each track according to at least three stages of activation: no power, power to the central part, and power to the smaller ends. There can be an intermediate position defined by a midpoint with a tactile stop to indicate the transition from the second stage to the third stage.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OM MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention, more particularly, relates to technical and functional improvements to be integrated in traditional stovetops also known as “cooktops” and defined as a heating area with one or more electric heating element.

Such types of stovetops always use a similar upper part comprising the whole area of support for the cooking utensils. This upper part is made of vitroceramic materials, and there are heating elements under it, as well as other electrical devices and electronic power controllers, timers and all kinds of components to control the heating elements.

### 2. Description of Related Art Including Information Disclosed Under 37 CFR 1.97 and 37 CFR 1.98.

As currently is known, there is a considerable variety of stovetops that operate with heating elements, including an electric heating element. All of them present, as a predominant feature, an entire cooking area that is defined by a vitroceramic upper part. Just above this upper part, heating elements are fitted in the form of electric heating elements. In most of the cases, each element provides a heating section for a container. Thus, only heating elements with a circular shape are known.

The prior art provides electrical stovetops with only one heating point or several points strategically placed to form units with just one to six burners. Some models also have additional areas for moderated heating (water bath) that are generally rectangular.

Therefore, the broad use of circular-shaped burners, instead of rectangular-shaped burners is predominant in most common stovetops. This technical condition forces the user to use the heating power of each burner, always being limited to its circular area; in other words, the heating area is predetermined and cannot increase nor decrease because of the arrangement of the heating element.

Considering the shape and arrangements of the usual burners, the user no longer has dimensional flexibility and comfortable usability in each burner, since it is unchangeable in two aspects: physical location and operational power for each burner. Logically such restrictions cause various drawbacks, i.e., regardless of the cooking container size, the burner equally initiates the operation, i.e., if it is a large container (pot, frying pan or the like) that occupies the entire burner or a small container (cup) occupying only the central part of the burner, the heating element will behave similarly for both containers, causing a considerable waste of heat and energy, not to mention that, the region will leave a large part of the surface heated and fully exposed, when the container is small or when the container is smaller than the circular area.

### BRIEF SUMMARY OF THE INVENTION

A new concept of a heating surface includes maintaining the use of vitroceramic upper part, but under it, the heating elements are arranged in an unprecedented way without a presence of “heating burner”. There is a large quadrangular heating area that extends along the entire upper part, leaving aside only a few free side edges and a larger edge for power control buttons.

This large quadrangular heating area is defined by a plurality of heating elements in the form of parallel and equidistant tracks. Each track is divided into three segments, a large central part and two smaller end parts. Each part can be connected electronically to a power source for heating. Behind each track, a corresponding sliding button is positioned for power control, such as switching on and off and controlling at least three stages of activation for each track. The large central part and the two smaller end parts can be activated as a unit, with the connections to start heating controlled by the sliding button. The heating by the central part and heating by the smaller end parts are coordinated by the position of the sliding button. In one embodiment, the stages of activation include a first stage being “off”, the second stage connecting to power or heating the larger central segment, and the third stage connecting to power or heating the smaller end segments. The smaller end parts or segments on both sides of the central part can be activated together to expand the heating area from the two sides of the central part. The central part and the smaller end parts can be controlled separately from each other.

In this condition, each track in the three segments is connected to power and controlled individually from each other. In this way, there are no individual burners, but rather a large heating area is formed by several tracks that can be activated in sufficient quantities so as to accommodate any size of recipients as either rounded or squared containers, such as pans. In this case, it is possible to set the quantities of tracks which are operating in order to achieve the required heating, in contrast to the prior art in which it is not possible to set quantities of tracks with circular heating burners.

Therefore, the main novelty of the invention is to provide a means for heating spots instead of heating burners, and such means are straight tracks, being parallel to each other instead of ordinarily circular tracks. In addition, the tracks are regularly spaced apart and independently operated, providing two key advantages for usability and flexibility in setting the size of the heating area.

The controls in the present invention are physical, in form of sliding buttons (as potentiometers) and do not operate as a “touch control”. It allows a more immediate, visual, tactile and precise operation, characterizing a more responsive and free flowing interaction.

Each heating track, as already said, is defined into three parts or segments, with gradual and independent actuating through the individual sliding controller button. The sliding button can control each of the central part, the first end part, and the second end part, as in a single control. The position of the sliding button determines when the central part starts heating and intensity of heating and when the first and second end parts start heating and intensity of heating. The first and second end parts can start heating together and change intensity of heating together. The sliding button can be split or bisected into indicators (separate sliding buttons or sub-buttons), so that each indicator of the sliding button controls a corresponding part. For example, one indicator can control the start of heating and intensity of heat for the central part and another indicator can control the start of heating and intensity of heat for the first end part and the second end part together. The control of the central part and the control of the first and second end parts is a multiple control. In other versions, the sliding button can be split into three indicators for each part to have its own indicator for control to start heating and intensity.

In an off position mode, the sliding controller buttons are turned down. This position mode is defined physically in its mechanism to provide an audible “click” and smooth resistance in their motion, in order to avoid accidental activation. At a middle point, each sliding controller button has a sensitive stopping point with another tactile feature. The tactile feature indicates the action of the central electric filament, which can be connected to power for heating first, and then the smaller ends at the extremes.

The sliding controls can be of two types: single or multiple. A single control has an action as already above described. Its restriction is to not turn on the outer segments or end parts, nor place all segments in an intermediate position.

A multiple sliding control can have bilateral activation. The sliding button itself is bisected into smaller sliding side buttons or indicators, wherein each side button or indicator can be moved in an independent or conjoined way. Each side button or indicator is a type of button responsible for one type of segments or parts, such as the central part or central segment and the end parts or peripheral segments. In an off position, the multiple sliding control button or indicators have similar characteristics as the simple control to start heating and to set intensity of heat. In turn, the heating activation is continuous and gradual, without an intermediate stopping point because each side or indicator of the control only corresponds to the respective type of segment or part. The advantage of the multiple sliding control allows all parts or segments to have, for example, an average temperature.

One should note that the actuators are also linear, providing a consistent design, and also demonstrating, in a simple and visual way, when they are turned off or when a precise temperature degree is set.

Depending on the container size (small pan, saucepan, kettle, frying pan, coffee maker, grill and others) and the quantity and spacing of tracks, the user will decide the tracks that will be activated and their intensity, respectively. The choice is variable. In the case of more than one container being utilized at the same time, some tracks will be optionally turned off only to create more space.

For example, if the objective is to boil water in a small Italian coffee pot, just two central parts or segments of adjacent tracks need to be activated. If a rectangular grill is used, five or more parts or segments of adjacent tracks will be connected at maximum intensity.

The interaction described above is flexible and at the same time responsive and free flowing, in contrast to traditional cooktops, wherein only the location of burners is set, and whose circular heating elements are predetermined.

It is a very common situation to put a large pan on a specific position on the stovetop. Unfortunately, there may be only a small burner or vice versa, a larger burner for a small pan. The linear stovetop of the present invention allows three small pots to be easily placed on the top part without being restricted to any one burner, since the number of tracks can be adjusted.

Observe that, by the fact that the stovetop or cooktop of the present invention is linear, the stovetop occupies a very small space (30-35 cm) in depth on the kitchen countertop and can be used in narrow spaces, such as kitchenettes. Furthermore, its main design allows it to be manufactured in variable widths with a number of tracks according to a manufacturer's marketing decision. In addition, implementing more than one line of tracks on the stovetop is possible, thus generating a square or rectangular layout for the heating area aligned in the cooking area of the top part.

### BRIEF DESCRIPTION OF THE SEVERAL VIEWS OF THE DRAWINGS

For better understanding of the present invention, follows it is made a detailed description thereof, making reference to the accompanying drawings.

FIG. 1 is an isometric schematic view, showing the stovetop at an anterosuperior angle.

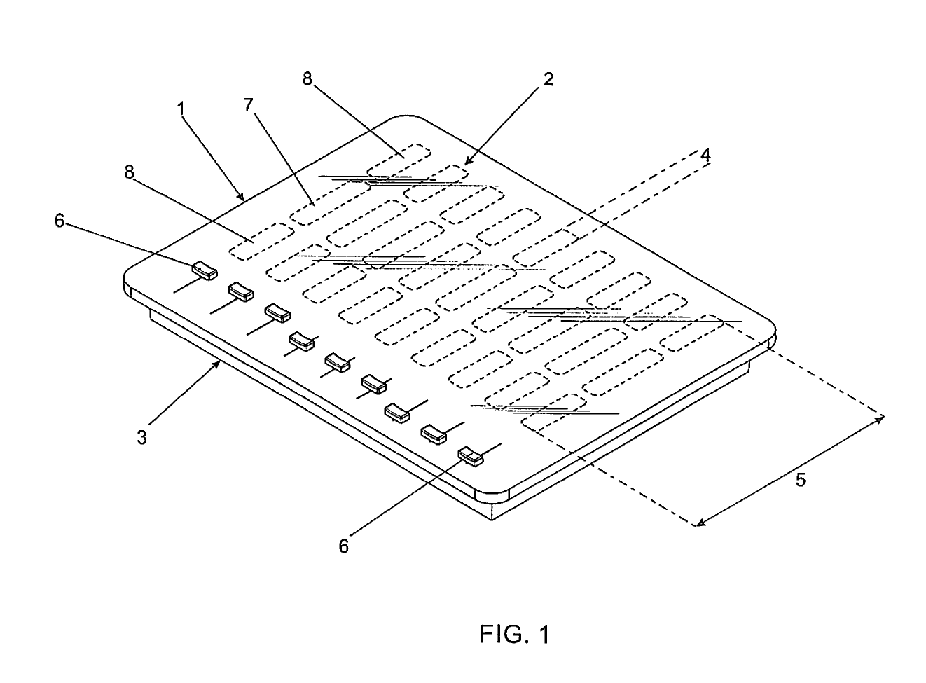

FIG. 2 is another isometric schematic view, showing the stovetop at a lower angle.

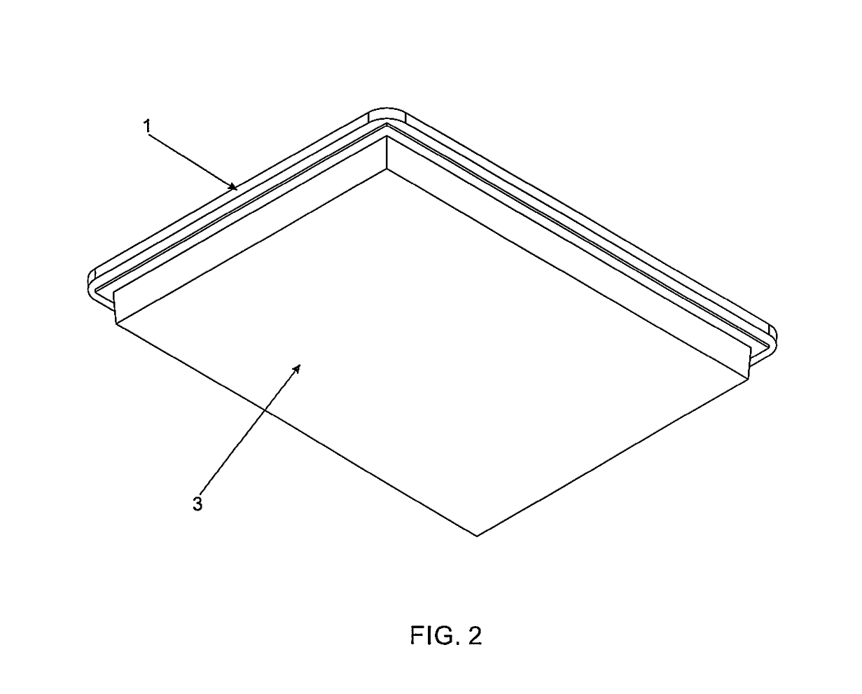

FIG. 3 illustrates a top plan view, schematically displaying the stovetop.

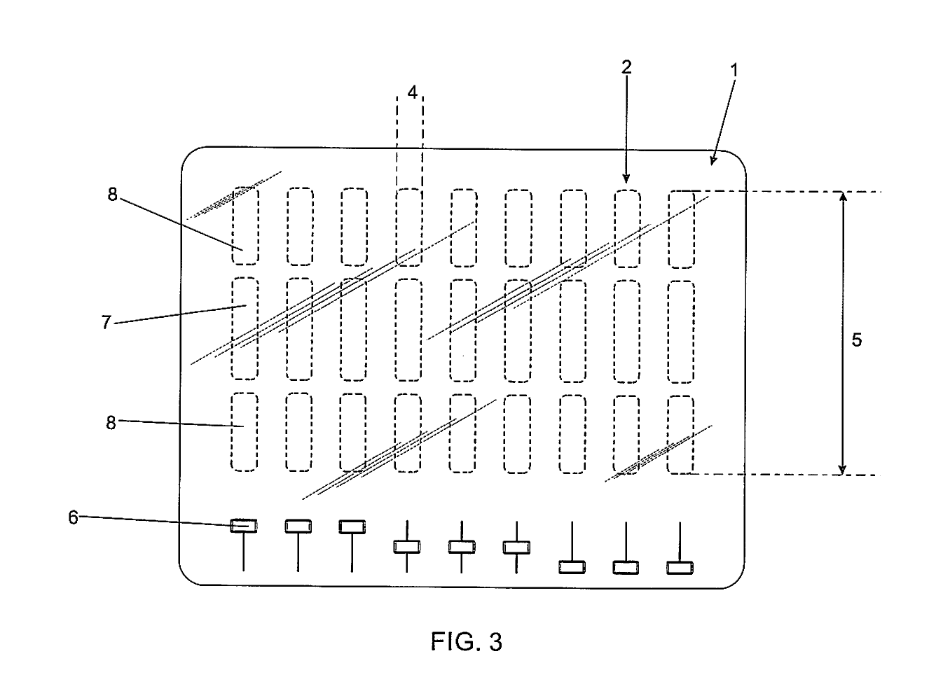

FIG. 4 is a front elevational view of the stovetop.

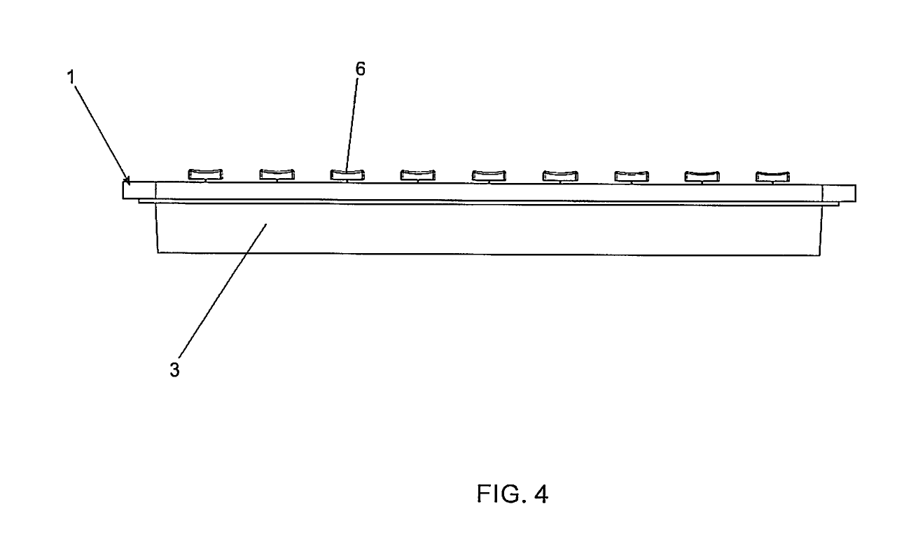

### DETAILED DESCRIPTION OF THE INVENTION

According to the illustrations and details in the figures, the present invention can be applied to several types of stovetops, also known as “cooktops”, usually formed by a vitroceramic top part (1). The stovetop comprises the cooking area as well as the electric heating element (2) that can be built-in below the top part, usually mounted on a bottom box for protection. The bottom box (3) also contains other electrical and electronic components, such as power controllers, timers and all other components for controlling the electrical heating elements (2). The controllers can be in communication with the heating element to connect power, determine activation of heating, and set intensity of heat.

The top part and bottom box (3) form a console to be built-in to any fitment or stove body, whose dimensions can be very large and usually defined by taking into account the design and decorative details of the assemblies. The console fits into different stove bodies.

The present invention is characterized by the fact that the heating elements, such as an electrical heating element (2) is comprised of parallel and equidistant tracks (4) that can reach close to the anterior edge to the superior near edge of the vitroceramic top part (1). The lateral combination of all tracks (4) form a large rectangular heating area (5) extending throughout and aligning with the cooking area of the vitroceramic top part (1), leaving only a few side edges and a large edge on the top part free. A sliding button of power control (6) is distributed and aligned parallel to said anterior edge. There can be a sliding button aligned to and in communication with a corresponding heating track (4). The position of the sliding button controls the heating of the respective track.

Each heating track (4) is divided into three segments, a large central part (7) and two smaller ends or end parts (8). Associated with each track, a corresponding sliding button of power control (6) is positioned relative to the respective track. The sliding button to control each track has at least three stages of activation. The first stage is “off”, and there is no connection to power of heating for any part of the track. The second stage connects power to heat and intensity of heat for the large central part of segment (7). The sliding button moves to control the start of heat and intensity of heat of the central part or segment. The third stage connects power to heat and intensity of heat for the smaller end parts or segments (8). The sliding button moves to control the start of heat and intensity of heat of the first and second end parts together. There is an intermediate position of the sliding button defined by a midpoint with a tactile feature stop between the second stage and the third stage. The user can feel or perceive when the sliding button starts heating the first and second end parts in the third stage. The user can control by feel of the sliding button, when the heating area is going to expand from the central part to include the smaller end parts.

It will be understood that certain features and constructive details of combinations are involved in the stovetop manufacturing, mainly in the construction of electrical heating elements and components involved for control of the heating elements or tracks (4), as well as in the dimensioning and quantity of heating tracks (4) which may vary considerably. Therefore, it is noted that the construction herein described is exemplary in details and clearly subject to constructive changes.

However, within the scope of the inventive concept herein disclosed, there is a stovetop that does not have heating burners, but rather a quadrangular total area of a heating area aligned with the cooking area of the top part and formed by parallel heating tracks controlled independently of each other. Thus, many modifications can still be made herein to the detailed configuration in accordance with the descriptive requirements of the law. It is understood that the details present should be interpreted as illustrative and non-limiting, as described above. The details achieve the objectives the invention, that is, each track (4) has three parts or segments (central part (7) and first and second end part (8)) and can be switched on and controlled independently of each other or in coordination. A large quadrangular heating area (5) formed by several tracks (4) can be activated in sufficient quantities by the respective sliding buttons (6) instead of traditional burners. The quadrangular heating area can be used for any size or shape of container, whether round or quadrangular. It is possible to set how many tracks are connected so as to be used for heating as required, and this choice adds flexibility to increase or decrease orthogonally the heating area in two directions, i.e. towards the left and right lateral edges and towards the anterior and posterior edges. The flexibility is not possible for a circular heating burner; thus, the use and flexibility in the size of heating area are great advantages of the invention over the prior art. The controls in the form of sliding buttons (6) are not “touch” but physicals (potentiometers), which provide more immediate, visual, tactile and precise operation, characterizing a more responsive and free flowing interaction.

1. An electric stovetop assembly, comprising:
a vitroceramic top part having a top surface defining a cooking area;
an electric heating element mounted below of the top part;
a bottom box below said electric heating element, said bottom box housing a controller, electrical components, and electronic components, said controller being in communication with said electrical heating elements; and
a plurality of sliding buttons on the top part, said sliding buttons being placed outside of said cooking area and along an edge of the top part,
wherein the top part and said bottom box form a console,
wherein said electrical heating elements is comprised of a plurality of heating tracks, each heating track being parallel and equidistant to a respective adjacent heating track, each heating track having a first end part, a central part, and a second end part, said central part being between said first end part and said second end part, said heating tracks forming a heating area aligned with said cooking area of said vitroceramic top part, and
wherein each heating track is aligned with a respective sliding button, each heating track being in communication with said respective sliding button so as to control heating of each heating track according to position of said respective sliding button.

2. The electric stovetop assembly, according to claim 1, wherein each track has three stages of activation, wherein a first stage is comprised of no power to any part of the heating track with said sliding button in an off configuration, wherein a second stage is comprised of power to said central part with said sliding button in a first power position, wherein a third stage is comprised of power to said first end part and said second end part with said sliding button in a second power position, and wherein said sliding button has a tactile stop in an intermediate position between said first power position and said second power position.

3. The electric stovetop assembly, according to claim 1, wherein said respective sliding button for each track is comprised of a plurality of sliding indicators, each part of the respective track being in communication with a respective indicator so as to control heating of each part of the respective track according to position of said respective indicator,
wherein a first respective indicator is in communication with said first end part of the respective track and position of said first respective indicator corresponds to power to said first end part,
wherein a second respective indicator is in communication with said second end part of the respective track and position of said second respective indicator corresponds to power to said second end part, and
wherein another respective indicator is in communication with said central part of the respective track and position of said another respective indicator corresponds to power to said central part.
